(19) United States
(12) Patent Application Publication
(10) Pub. No.: US 2004/0069640 A1
(43) Pub. Date: Apr. 15, 2004

(54) Tubular electrodialysis and electrodeposition membrane electrode device

(76) Inventors: Roberto Pizzamiglio, San Felice Segrate (IT); Claudio Moretti, Milano (IT); J?uuml;rgen Weschke, Weil Der Stadt (DE)

Correspondence Address: Myers Dawes Andras & Sherman, Suite 1150, 19900 MacArthur Boulevard, Irvine, CA, 92612, US

(21) Appl. No.: 10/415,241

(22) PCT Filed: Aug. 22, 2002
(86) PCT No.: PCT/IT02/00547

(30) Foreign Application Priority Data
Aug. 28, 2001 (IT) TO2001A000835

(51) Int. Cl. B01D 61/42

(52) U.S. Cl. 204/640; 204/626

(57) ABSTRACT

A tubular electrodeposition and electrodialysis cell (1), in particular for painting processes by immersion in a paint bath, having preferably a rigid supporting structure (8), at least one electrode (7), to separate the paint bath from a dialysis liquid circulating in the cell; members (21, 24, 41, 42, 46) are provided which cooperate with the supporting structure (8) to fit the membrane (9) hermetically to the supporting structure (8) and permit removal of the membrane.

### TECHNICAL FIELD

The present invention relates to a tubular electrodeposition and electrodialysis cell, in particular for painting processes by immersion in a paint bath.

### BACKGROUND ART

As is known, in electrodeposition coating or painting processes, the object to be painted is immersed in a paint bath in a tank. By generating an appropriate electric field in the bath, the paint particles migrate and adhere to the surface of the object for painting to form an even coating.

In such processes, tubular electrodeposition and electrodialysis cells perform the twofold function of generating the electric field required for electrodeposition of the paint coating (i.e. act as an electrode in the electrodeposition process, the opposite electrode being defined by the object for painting), and of acting as a dialysis cell to remove ions from the paint bath to keep its chemical characteristics (specifically, its acidity) constant. Each tubular cell therefore generally comprises a supporting structure, a tubular metal electrode, and a semipermeable membrane, which define a channel for circulating a dialysis liquid (electrolyte) inside the cell; and the membrane is fitted to the supporting structure at a given distance from the electrode to separate, in use, the paint bath in the tank from the electrolyte circulating in the cell.

The supporting structure of known tubular cells normally comprises a flexible net about which the membrane is wound, and which extends along the whole length of the membrane. To seal the cell and prevent contamination of the electrolyte by the paint bath, the membrane of known tubular cells is glued and/or welded to the supporting structure, and, being defined by a sheet element, must be welded not only at the axial ends of the tubular cell, but also along a longitudinal seam.

Such membranes, however, have the drawback of being exposed, in use, to wear and damage. The membranes normally used in such applications, in fact, are invariably fragile and deteriorate rapidly; and, when installing, servicing, or even operating the cells, objects may accidentally come into contact with the cells, and therefore with the membranes defining the most exposed cell surface. As is known, if the membrane is perforated, operation of the whole cell is drastically and irreversibly impaired by mutual contamination of the electrolyte and the paint bath.

And since the membrane is fixed permanently to the cell, the whole cell must be replaced in the event of damage, structural defects or wear of the membrane.

### DISCLOSURE OF INVENTION

It is an object of the present invention to provide a tubular cell designed to eliminate the aforementioned drawbacks of the known state of the art.

According to the present invention, there is provided a tubular electrodeposition and electrodialysis cell comprising at least one electrode; a supporting structure; and a semipermeable membrane carried by the supporting structure and surrounding said electrode, at a given distance from the electrode; the tubular cell having a dialysis liquid circulating channel extending at least partly between the semipermeable membrane and the electrode; and the tubular cell being characterized by comprising members cooperating with the supporting structure to fit said semipermeable membrane hermetically and releasably to the supporting structure, so as to permit replacement of said semipermeable membrane.

The tubular cell according to the invention provides, in the event of wear, damage or defects on the membrane, for restoring the efficiency of the tubular cell by simply replacing the membrane as opposed to the whole, or a major part, of the tubular cell. The membrane can be replaced quickly and easily in a few simple operations, while at the same time ensuring effective sealing of the membrane, and the tubular cell as a whole is relatively cheap and easy to produce and assemble.

An important aspect of the invention lies in the supporting structure, to which the membrane is fitted, being rigid, thus, among other things, increasing the exchange surface of the membrane as compared with known solutions. That is, whereas, with a flexible supporting net, the membrane supporting function calls for a relatively tight mesh, a rigid supporting structure enables the formation of relatively large flow passages.

### BRIEF DESCRIPTION OF THE DRAWINGS

A non-limiting embodiment of the present invention will be described by way of example with reference to the accompanying drawings, in which:

FIG. 1 shows a schematic side view, with parts shown partly in section and parts removed for clarity, of a tubular cell installed in a paint tank;

FIGS. 2 and 3 show respective sections along lines II-II and III-III in FIG. 1;

FIGS. 4 and 5 show views in perspective of respective component parts of the FIG. 1 cell;

FIG. 6 shows a partial rear view of the FIG. 1 cell;

FIG. 7 shows a schematic side view, with parts shown partly in section and parts removed for clarity, of a further embodiment of the cell according to the invention;

FIG. 8 shows a section along line VIII-VIII in FIG. 7;

FIG. 9 shows a schematic side view, with parts shown partly in section and parts removed for clarity, of a further embodiment of the cell according to the invention;

FIGS. 10 and 11 show schematic, partly sectioned views, along line X-X in FIG. 9, of steps in the assembly of the FIG. 9 cell;

FIG. 12 shows a section along line XII-XII in FIG. 9;

FIG. 13 shows a schematic side view, with parts shown partly in section and parts removed for clarity, of a further embodiment of the cell according to the invention;

FIGS. 14 and 15 show respective larger-scale details of the FIG. 13 cell.

### BEST MODE FOR CARRYING OUT THE INVENTION

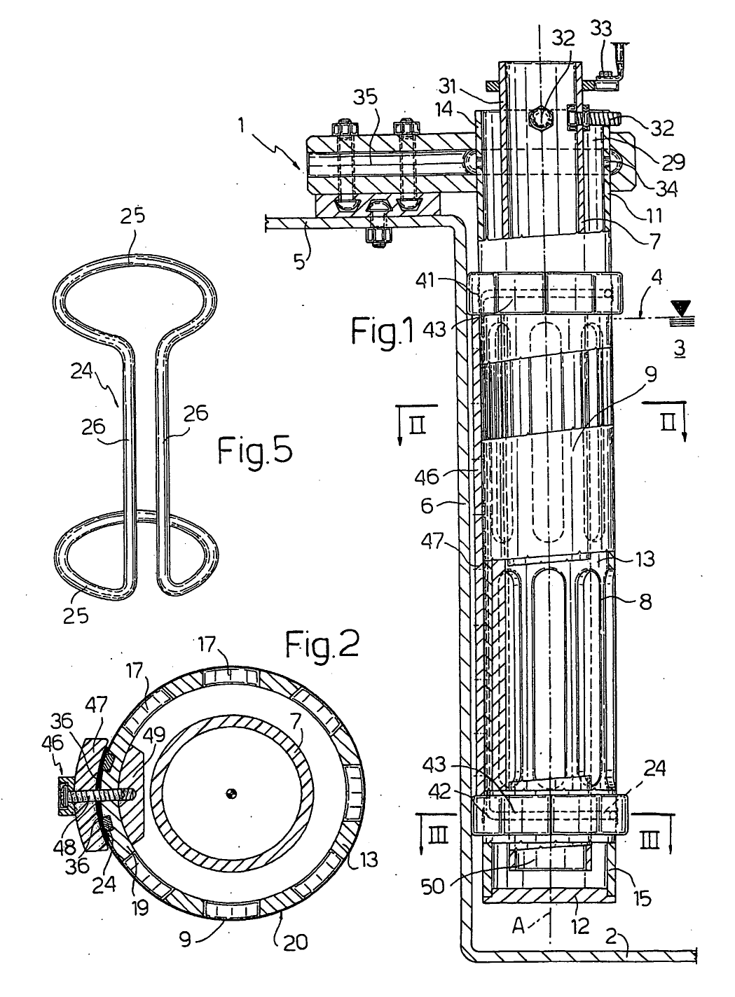

Number 1 in FIG. 1 indicates as a whole a tubular electrodeposition and electrodialysis cell installed in a tank 2 containing a paint bath 3 up to a given level defined by a free surface 4. Cell 1 is fixed to an edge 5 of tank 2, close to a lateral wall 6 of tank 2, in known manner not described in detail for the sake of simplicity.

Cell 1 comprises an electrode 7; a supporting structure 8; and a semipermeable membrane 9 carried by supporting structure 8 and surrounding electrode 7, at a given distance from electrode 7.

Electrode 7 is a tubular electrode defined by a straight hollow cylinder extending along a central axis A of symmetry of cell 1.

Supporting structure 8 is a rigid structure comprising a head 11; a bottom cap 12; and a straight, circular-section, rigid tubular body 13 made, for example, of rigid polymer material. Tubular body 13 is coaxial with and located radially outwards with respect to electrode 7, and has two opposite, respectively top and bottom, open axial ends 14, 15; head 11 is defined by an end portion of tubular body 13 at axial end 14; and cap 12 is-welded (or fixed in fluidtight manner in any other way) to axial end 15 of tubular body 13.

As shown particularly in FIG. 4, a number of ample radial windows 17 are formed in a cylindrical lateral wall 16 of tubular body 13, are defined in the example shown by axially elongated longitudinal slits spaced circumferentially apart, are arranged in parallel superimposed rows to define a grille, and are defined and separated from one another by strip portions 18 of tubular body 13. Lateral wall 16 comprises a solid axial portion 19 with no openings; the axial dimension of each window 17 is much greater than its circumferential dimension; and the total area of windows 17 is greater than the solid area of lateral wall 16.

A radially outer lateral surface 20 of lateral wall 16 comprises a continuous groove 21 extending along an endless path and comprising two substantially parallel circumferential portions 22, and two substantially parallel, closely adjacent, straight axial portions 23 formed in axial portion 19 of lateral wall 16, and connecting and perpendicular to circumferential portions 22.

Groove 21 houses an endless seal 24 made, for example, of deformable elastomeric material, and which, when housed inside groove 21, assumes a work configuration (FIG. 5) comprising two eyelets 25 housed in circumferential portions 22 of groove 21, and two straight portions 26 housed in axial portions 23 of groove 21. When housed in groove 21 and undeformed, seal 24 has a cross section such as to project radially from groove 21.

Head 11 (FIG. 4) terminates with an annular end edge 27 having three circumferentially spaced connecting seats 28 defined, for example, by respective slots. Both the number and arrangement of seats 28 on edge 27, however, may differ from those indicated herein purely by way of example.

Tubular body 13 has an inner seat 29 for housing electrode 7; electrode 7 is provided, at the top end 31, with three radially outer fastening members 32 defined, for example, by respective bolts screwed to the lateral wall of electrode 7 and positioned to correspond with connecting seats 28; fastening members 32 are inserted axially inside connecting seats 28 to support electrode 7 inside seat 29; electrode 7 projects downwards to a given distance from cap 12; and end 31 of electrode 7 carries a known electric connector 33 for supplying electrode 7.

Head 11 comprises radially through holes 34 connected to an outlet fitting 35.

Membrane 9, in itself known, is defined by a substantially rectangular, suitably semipermeable sheet of a length (measured axially along axis A) smaller than the axial length of tubular body 13 but greater than the axial distance between circumferential portions 22 of groove 21.

Membrane 9 is wound about lateral surface 20 of tubular body 13 (FIG. 2) two end portions 36 of membrane 9 are superimposed on solid axial portion 19 of lateral wall 16 so that, in use, membrane 9 assumes a continuous tubular configuration.

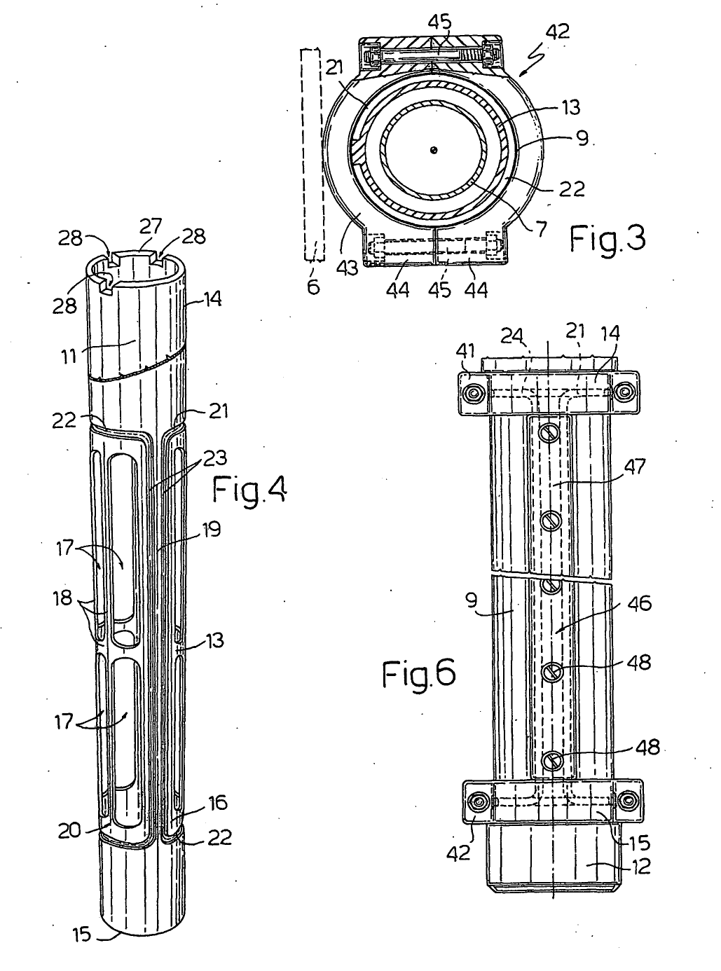

Two fastening assemblies 41, 42 are fitted over circumferential portions 22 of groove 21, and each comprise a fastening ring 43 (FIG. 3) defined by two half-rings 44 fitted releasably to each other by known diametrically opposite threaded fastening members 45. Half-rings 44 have respective semicircular inner lateral surfaces which rest on tubular body 13 to grip, in use, respective axial ends of membrane 9 against lateral surface 20 of tubular body 13, with the interposition of seal 24.

A third fastening assembly 46 (FIGS. 1, 2 and 6) comprises a fastening bar 47 extending longitudinally between fastening rings 43 and over solid axial portion 19 of lateral wall 16 and therefore over axial portions 23 of groove 21 and superimposed portions 36 of membrane 9. Fastening bar 47 has a number of axially spaced threaded fastening members 48 which are inserted, in use, through portions 36 of membrane 9 to engage respective seats formed in a mating member 49 housed inside supporting structure 8, and so grip superimposed portions 36 of membrane 9 against lateral surface 20 of tubular body 13, with the interposition of seal 24.

In actual use, a channel 50 for circulating a dialysis liquid (electrolyte) is defined inside cell 1. More specifically, the dialysis liquid is fed into electrode 7 through end 31 and, on reaching cap 12, flows back up, inside the annular gap defined by the outer lateral surface of electrode 7 and by membrane 9, to head 11 and out through outlet fitting 35. Windows 17 define respective flow passages through which ions are exchanged between the dialysis liquid circulating in cell 1 and bath 3.

Operation of cell 1 is identical with that of known tubular cells and is therefore not described in detail for the sake of simplicity.

In the event of damage or wear, membrane 9 is replaced by simply releasing fastening assemblies 41, 42, 46 (by unscrewing respective threaded fastening members 45, 48), removing membrane 9, winding a new membrane about tubular body 13, and fitting the new membrane hermetically to tubular body 13 by retightening fastening assemblies 41, 42, 46.

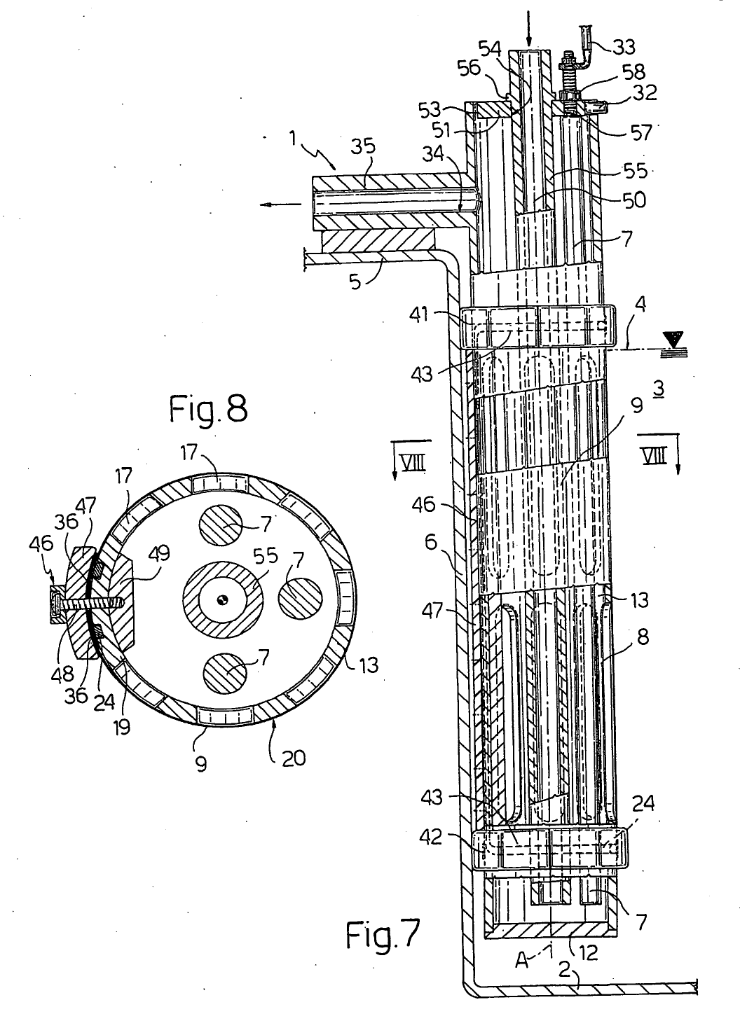

FIGS. 7 and 8 show a different version of cell 1 which, in this case, as opposed to a single tubular electrode, houses a number of electrodes 7 defined by solid, circular-section cylindrical bars and arranged about axis A. Electrodes 7 are supported by a disk-shaped electrode-holder plate 51 having three radially outer fastening members 32 (only one shown in FIG. 7) which project radially from a lateral edge 53 of electrode-holder plate 51 and are defined, in the example shown, by respective threaded rods screwed inside corresponding nut screw seats formed in lateral edge 53. Fastening members 32 are positioned to correspond with connecting seats 28 on head 11, and are inserted axially inside connecting seats 28 to support electrode-holder plate 51.

Electrode-holder plate 51 has a central hole 54 for housing a tube 55 made, for example, of PVC or other suitable polymer material, and supported by means of a radially outer collar 56 cooperating with a peripheral edge of central hole 54.

Electrode-holder plate 51 has through seats 57 (only one shown in FIG. 7) arranged substantially about central hole 54 (and therefore about axis A). In the example shown, three seats 57 are provided in positions corresponding with fastening members 32, though both the number and arrangement of seats 57 on electrode-holder plate 51 may differ from those shown herein by way of example.

Respective top ends of electrodes 7 are inserted inside seats 57. Each electrode 7 has a radially outer fastening portion 58 (defined, for example, by a nut screwed to a threaded portion of electrode 7, or by a radial flange) which rests on a peripheral edge of respective seat 57 to secure electrode 7 axially inside seat 57.

Both tube 55 and electrodes 7 project downwards to a given distance from cap 12; tube 55, which is open at the bottom, defines a channel for circulating dialysis liquid inside cell 1; and the dialysis liquid flows back up inside the annular gap defined by tube 55 and membrane 9.

One of electrodes 7 has a known electric connector 33, and current is supplied to the other electrodes by electrode-holder plate 51 (if made of conducting material) or by a further connecting member (not shown).

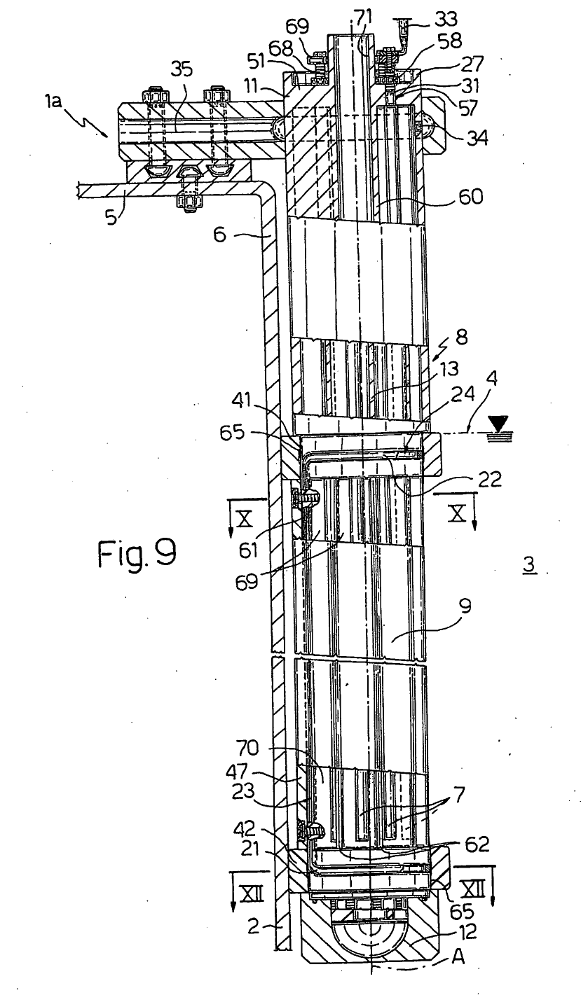

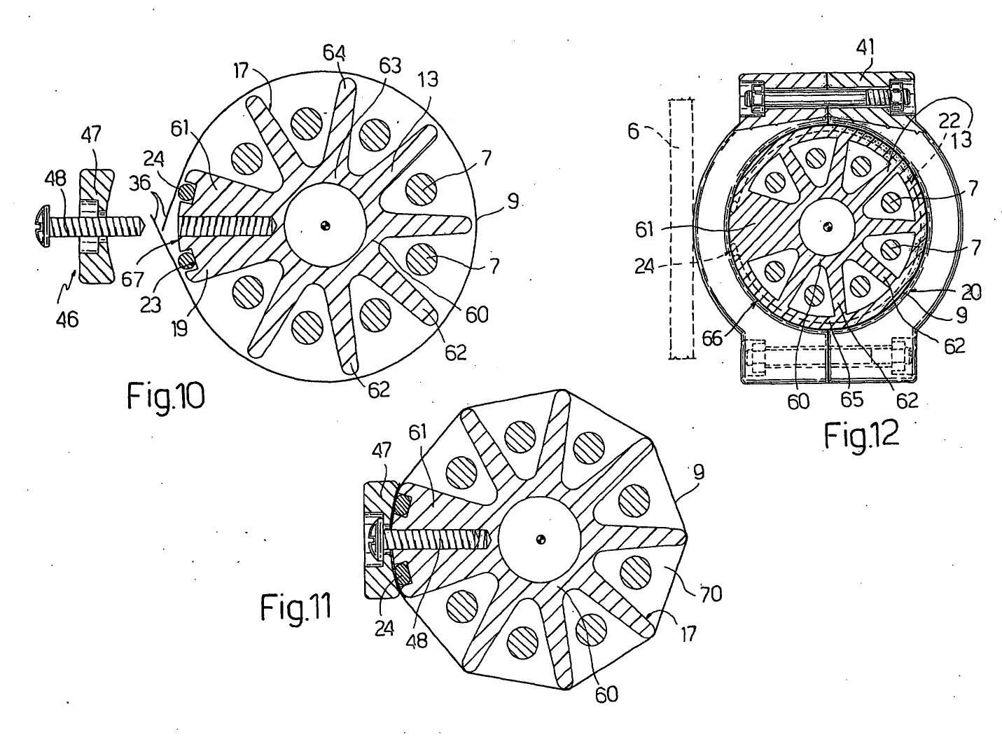

FIGS. 9 to 12—in which any details similar to or identical with those already described are indicated using the same reference numbers—show a variation la of the tubular cell according to the invention, and again installed in a paint tank 2.

Cell 1a again comprises a rigid supporting structure 8 in turn comprising a head 11, a bottom cap 12, and a straight rigid tubular body 13, e.g. an extruded section of rigid polymer material. In this case, however, tubular body 13 comprises a circular-section central tubular member 60 having a straight axis coincident with axis A, and integrally supporting a solid longitudinal rib 61 parallel to tubular member 60, and a number of longitudinal arms 62 also parallel to tubular member 60. Arms 62 are arranged radially about tubular member 60, are spaced circumferentially apart, and project radially from tubular member 60 to define a number of seats for respective electrodes 7. Rib 61 and arms 62 extend longitudinally along a given portion of tubular member 60; and arms 62 comprise respective connecting ends 63 for connection to tubular member 60, and respective rounded free ends 64, and each have a cross section tapering from connecting end 63 to free end 64.

Tubular body 13 also comprises two axially spaced collars 65 fitted radially outwards about arms 62, having respective radially outer cylindrical lateral surfaces 66, and connected to each other by rib 61, which has a curved radially outer surface 67 on the opposite side to tubular member 60 and connected seamlessly to lateral surfaces 66 of collars 65.

The gaps between free ends 64 of arms 62 define respective ample radial windows 17 defined and separated from one another by arms 62; each window 17 has an axial dimension much greater than its circumferential dimension; and rib 61 defines a solid axial portion 19, with no openings, of tubular body 13.

A lateral surface 20 of tubular body 13 comprises a continuous groove 21 extending along an endless path and in turn comprising two substantially parallel circumferential portions 22 formed in lateral surfaces 66 of collars 65, and two straight substantially parallel axial portions 23 connecting and perpendicular to circumferential portions 22, and formed in surface 67 of rib 61. As described previously, groove 21 houses an endless seal 24 which, when housed in groove 21, assumes the same work configuration as shown in FIG. 5.

Electrodes 7 are defined by respective straight, circular-section, solid bars, and are located between arms 62 and parallel to tubular member 60, and therefore to axis A.

Electrodes 7 are supported by an electrode-holder plate 51 defined by a transverse disk-shaped cover carried integrally in one piece by body 13 and closing the open top end of head 11; tubular member 60 is fitted centrally through electrode-holder plate 51, which has a number of through seats 57 parallel to and arranged about axis A; and respective top axial ends 31 of electrodes 7 are inserted inside seats 57, and have respective radial fastening portions 58 (e.g. defined by nuts screwed to respective threaded rods) which, when electrodes 7 are installed, rest on a top face of electrode-holder plate 51 and on respective peripheral edges of seats 57.

Bolts 68 also fix ends 31 of electrodes 7 to an annular connecting plate 69 located over electrode-holder plate 51 to connect electrodes 7, and comprising an electric connector 33.

Membrane 9, again defined by a substantially rectangular sheet of suitable semipermeable material, is wound about supporting structure 8. More specifically, membrane 9 is stretched over the free ends 64 of arms 62, and two end portions 36 of membrane 9 are superimposed and fitted to surface 67 of rib 61, so that membrane 9 assumes, in use, a closed polygonal configuration.

Membrane 9 is also wound about lateral surfaces 66 of collars 65, and, as already described, fastening assemblies are provided to grip membrane 9, in use, against lateral surface 20 of tubular body 13, with the interposition of seal 24. More specifically, two fastening assemblies 41, 42 (identical with those already described) are fitted to axial ends 14, 15 of tubular body 13 to cooperate with collars 65; a third fastening assembly 46 comprises a fastening bar 47 extending longitudinally between fastening assemblies 41, 42 and over rib 61, to which it is secured releasably by a number of axially spaced threaded fastening members 48; and threaded fastening members 48 are inserted, in use, through portions 36 of membrane 9 to engage respective seats formed in rib 61.

A channel 50 for circulating an electrolytic dialysis liquid is also defined inside cell 1a. In this case, the dialysis liquid is fed through an open top end 71 of tubular member 60 and, on reaching cap 12, flows back up, along conduits 70 defined on the outside of tubular member 60 by arms 62 and membrane 9, to head 11 and out through outlet fitting 35. Ion exchange between the dialysis liquid circulating in cell 1a and bath 3 occurs through windows 17 closed by membrane 9.

In this variation too, in the event of damage or wear, membrane 9 is replaced by simply releasing fastening assemblies 41, 42, 46, removing membrane 9, replacing it with a new membrane, and reassembling fastening assemblies 41, 42, 46.

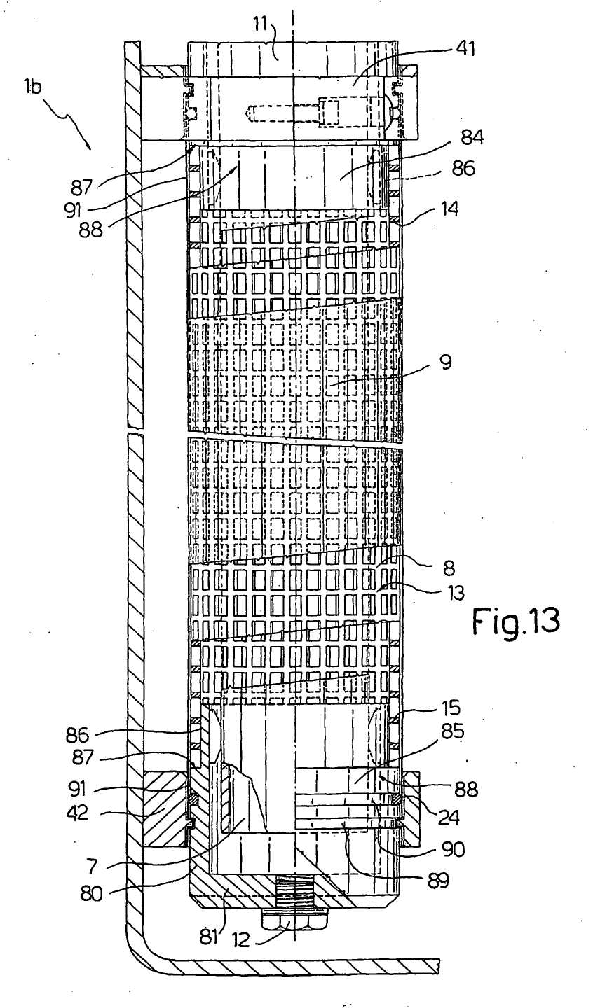

A further variation 1b of the cell according to the invention is shown in FIGS. 13 to 15 (in which any details similar to or identical with those already described are indicated using the same reference numbers). Cell 1b (the top part of which is identical with that of cell 1 in FIG. 1 and therefore not shown in FIG. 13) also comprises a supporting structure 8 housing an electrode 7 and supporting a semipermeable membrane 9. Supporting structure 8 comprises a straight tubular body 13 which is coaxial with and radially outwards with respect to electrode 7, and is connected at opposite (respectively top and bottom) open axial ends 14, 15 to a head 11 and, respectively, to an end portion 80 having a bottom wall 81 in which is formed a through hole closed by a removable cap 12.

Head 11 and end portion 80 are defined by respective cylindrical tubes made of polymer material, e.g. polypropylene, and comprise respective substantially cylindrical connecting portions 84, 85 for connection to respective axial ends 14, 15 of tubular body 13. Connecting portions 84, 85 are substantially similar, are positioned specularly facing each other, and terminate with respective cylindrical ledges 86 facing each other and defined by respective annular shoulders 87. An outer lateral surface 88 of each connecting portion 84, 85 has two parallel circumferential grooves 89, 90 (FIG. 15).

Axial ends 14, 15 are fitted to and fixed to cylindrical end ledges 86 in any known manner (e.g. welded or force-fitted).

Tubular body 13 is in the form of a grille or net, and is preferably substantially rigid or semirigid and made of polymer material, e.g. PVC or polypropylene (PP).

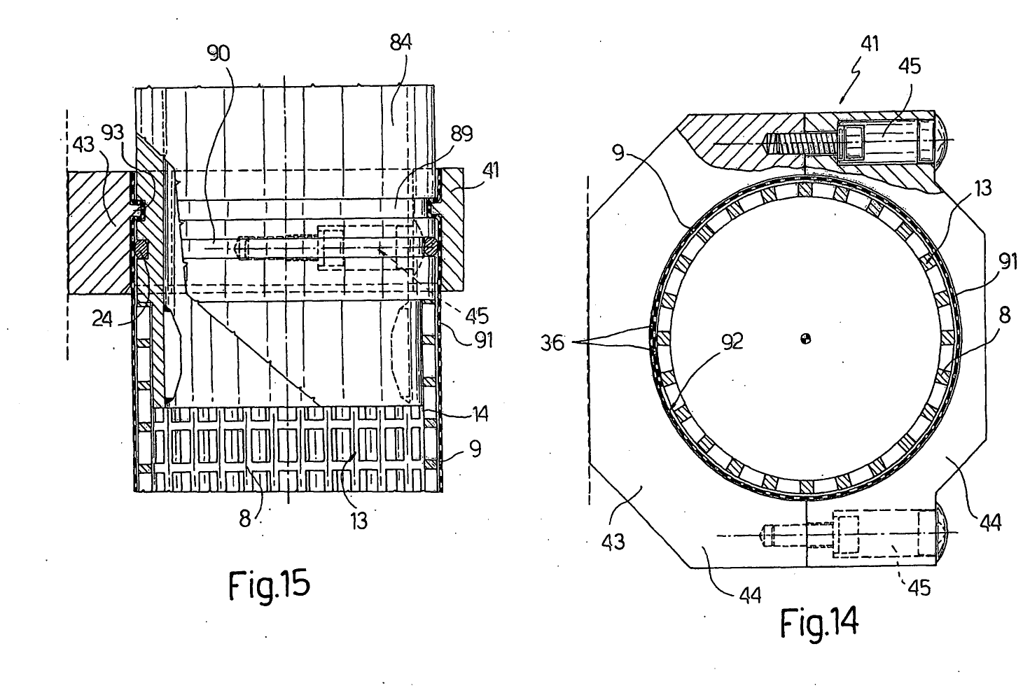

Membrane 9 is a tubular membrane defined for example (FIG. 14) by a rectangular sheet having two superimposed end portions 36 welded longitudinally in fluidtight manner along substantially their whole length, or is made in known manner in the form of a seamless tube. Whichever the case, all portions of membrane 9, including the join of portions 36, have the same semipermeable characteristics.

Membrane 9 is wound about tubular body 13 so that axial end portions 91 cover respective connecting portions 84, 85 of head 11 and end portion 80, and in particular grooves 89, 90.

Two fastening assemblies 41, 42 are fitted over connecting portions 84, 85 and, in particular, over pairs of grooves 89, 90, and each comprise a fastening ring 43 defined by two half-rings 44 fitted releasably to each other by known diametrically opposite threaded fastening members 45. Fastening rings 43 have respective substantially circular inner lateral surfaces 92 by which to rest on lateral surfaces 88 of connecting portions 84, 85, and have respective radially inner annular projections 93 by which to engage grooves 89. Grooves 90, on the other hand, house respective seals 24 (e.g. O-ring seals made of elastomeric material).

In actual use, fastening assemblies 41, 42 grip axial end portions 91 of membrane 9 against connecting portions 84, 85, with the interposition of seals 24, and membrane 9 is pinched between projections 93 and grooves 89 engaged by projections 93.

Membrane 9 is replaced by simply releasing fastening assemblies 41, 42 (by unscrewing respective threaded fastening members 45), removing membrane 9 (by withdrawing it axially or even cutting it), winding a new membrane about tubular body 13, fixing the new membrane hermetically to tubular body 13, and retightening fastening assemblies 41, 42.

Clearly, changes may be made to the tubular cell as described and illustrated herein without, however, departing from the scope of the present invention.

1) A tubular electrodeposition and electrodialysis cell (1, 1a, 1b) comprising at least one electrode (7); a supporting structure (8); and a semipermeable membrane (9) carried by the supporting structure and surrounding said electrode, at a given distance from the electrode; the tubular cell having a dialysis liquid circulating channel (50) extending at least partly between the semipermeable membrane and the electrode; and the tubular cell being characterized by comprising members (21, 24, 41, 42, 46) cooperating with the supporting structure (8) to fit said semipermeable membrane (9) hermetically and releasably to said supporting structure (8), so as to permit replacement of said semipermeable membrane.

2) A tubular cell as claimed in claim 1, characterized in that said supporting structure (8) is a rigid structure; said semipermeable membrane (9) being supported by the rigid structure.

3) A tubular cell as claimed in claim 2, characterized in that the rigid said supporting structure (8) comprises a rigid tubular body (13) having a number of windows (17) defining a grille; the semipermeable membrane (9) closing said windows (17).

4) A tubular cell as claimed in claim 3, characterized in that said tubular body (13) is longer than the semipermeable membrane (9).

5) A tubular cell as claimed in claim 3 or 4, characterized in that said windows (17) are axially elongated radial openings having an axial dimension much greater than the circumferential dimension.

6) A tubular cell as claimed in one of claims 3 to 5, characterized in that said tubular body (13) is a cylindrical body defining internally a seat for housing one or more electrodes (7).

7) A tubular cell as claimed in one of claims 3 to 5, characterized in that said tubular body (13) comprises a central tubular member (60), and a number of radial arms (62) carried by the central tubular member (60) and defining a number of seats for housing respective electrodes (7).

8) A tubular cell as claimed in claim 6 or 7, characterized in that said tubular body (13) comprises a groove (21) extending along an endless path and housing an endless seal (24).

9) A tubular cell as claimed in claim 8, characterized in that said groove (21) comprises two circumferential portions (22) formed at opposite axial ends (14, 15) of the tubular body (13), and two straight axial portions (23) closely adjacent to each other and connecting the circumferential portions (22).

10) A tubular cell as claimed in claim 9, characterized in that said semipermeable membrane is a sheet having two end portions (36) superimposed one on the other and over said axial portions (23) of the groove (21).

11) A tubular cell as claimed in claim 10, characterized in that said members comprise fastening assemblies (41, 42, 46) for gripping the semipermeable membrane (9) to the tubular body (13), with the interposition of said seal (24).

12) A tubular cell as claimed in claim 11, characterized in that said members comprise two fastening rings (43) superimposed over said circumferential portions (22) of the groove (21).

13). A tubular cell as claimed in claim 12, characterized in that said members comprise a fastening bar (47) extending longitudinally between said fastening rings (43) and superimposed over said axial portions (23) of the groove (21).

14) A tubular cell as claimed in claim 1, characterized in that said semipermeable membrane (9) is a tubular membrane defined by a sheet having two superimposed, longitudinally welded end portions (36), or is made in the form of a seamless tube.

15) A tubular cell as claimed in the foregoing claim, characterized in that said supporting structure (8) comprises a tubular body (13) in the form of a net or grille on which the semipermeable membrane (9) is wound, and two connecting portions (84, 85) located at opposite axial ends (14, 15) of the tubular body (13) and having respective grooves (90) housing respective endless seals (24); said members comprising two fastening rings (43) superimposed over said grooves (90) to grip the semipermeable membrane (9) to said connecting portions (84, 85), with the interposition of said seals (24).
